(19) United States
(12) Patent Application Publication
(10) Pub. No.: US 2005/0078076 A1
(43) Pub. Date: Apr. 14, 2005

(54) Scan driver, display device having the same, and method of driving display device

(76) Inventors: Sang-Soo Kim, Seoul (KR); Seung-Hwan Moon, Yongin-si (KR); Jheen-Hyeok Park, Seongnam-si (KR); Hoi-Sik Moon, Hwaseong-si (KR)

Correspondence Address: McGuireWoods;Suite 1800, 1750 Tysons Boulevard, McLean, VA, 22102-4215, US

(21) Appl. No.: 10/868,915

(22) Filed: Jun. 17, 2004

(30) Foreign Application Priority Data
Sep. 25, 2003 (KR) 2003-66490

(51) Int. Cl. G09G 3/36

(52) U.S. Cl. 345/98

(57) ABSTRACT

A scan driver employs an impulse-type display so as to display a moving picture. A display panel includes a plurality of pixels having a first switching elements and a second switching element that is coupled to one of clear lines and one of data lines. A data driver provides a picture signal to the data lines. A scan driver provides a first control signal to the scan lines so that the pixel may be charged with the picture signal, and provides a second control signal to the clear lines so that the picture signal charged in the pixel may be discharged via the second switching element. Accordingly, display characteristics of a moving picture of a display device having the scan driver may be enhanced.

### CROSS REFERENCE TO RELATED APPLICATION

This application claims priority under 35 USC § 119 to Korean Patent Application No. 2003-66490, filed on Sep. 25, 2003, the contents of which are herein incorporated by reference in their entirety for all purposes.

### BACKGROUND OF THE INVENTION

1. Field of the Invention

The present invention relates to a scan driver of a display device and a method of driving the display device.

2. Description of the Related Art

A liquid crystal display (hereinafter, referred to as LCD) device controls brightness by controlling an intensity of light emitted from a light source, while a conventional CRT controls brightness by controlling an intensity of scanned electric ray.

A technology of displaying a moving picture has been developed as well as a technology of displaying a still picture. However, an LCD device displaying the moving picture has a poor quality because of following reason.

When a charged voltage (for example, a picture signal or a data voltage) applied to a liquid crystal is maintained during a time period corresponding to one frame and another data voltage is applied to the liquid crystal in next frame, a ghost image may be remain in a screen since a response speed of the liquid crystal is slower than a one-frame period (or a time period corresponding to one frame).

### SUMMARY OF THE INVENTION

Accordingly, the present invention is provided to substantially obviate one or more problems due to limitations and disadvantages of the related art.

According to some embodiments of the present invention, there is provided a scan driver for enhancing a display quality of a moving picture.

According to other embodiments of the present invention, there is provided a display device having the scan driver.

According to still other embodiments of the present invention, there is provided a method of driving the display device.

In some exemplary embodiments, the scan driver includes a first driver and a second driver. The first scan driver provides a first control signal to at least one scan line coupled to a pixel, a picture signal being provided to the pixel in response to the first control signal. The second driver provides at least one second control signal to at least one clear line coupled to the pixel, the picture signal being discharged in response to the second control signal control.

In another exemplary embodiments, in a scan driver for driving a display device having a plurality of pixels, and a plurality of data lines, a plurality of scan lines, and a plurality of clear lines that are coupled to the pixels, the scan driver includes a first driver and a second driver. The first driver is configured to provide a first control signal to the at least one of the scan lines, and configured to control at least one pixel of the pixels so that the at least one pixel is charged with a picture signal in response to the first control signal. The second driver is configured to provide at least one second control signal to at least one of the clear lines so that the charged picture signal of the at least one pixel is discharged in response to the second control signal.

In still another exemplary embodiments, the display device includes a display panel, a data driver and a scan driver. The display panel includes a plurality of scan lines, a plurality of data lines, a plurality of clear lines, and a plurality of pixels having a first and a second switching elements, the first switching element being coupled to one of the scan lines and one of the data lines, and the second switching element being coupled to one of the clear lines and one of the data lines. The data driver is configured to provide a picture signal to the data lines. The scan driver is configured to provide a first control signal via the scan lines to the first switching element so that the pixel may be charged with the picture signal in response to the first control signal, and is configured to provide a second control signal via the clear lines to the second switching element so that the picture signal charged in the pixel may be discharged via the second switching element in response to the second control signal.

In still further exemplary embodiments, the display device includes a display panel including a plurality of scan lines, a plurality of data lines, a plurality of clear lines, and a plurality of pixels coupled to the scan lines, the data lines and the clear lines. The display device further includes a data driver, a first scan driver and a second scan driver. Tdata driver is configured to provide a picture signal to the data lines. The first scan driver includes a first driver and a second driver. The first driver provides a first control signal to a first pixel coupled to one of odd-numbered scan lines so that the first pixel may be charged with a picture signal in response to the first control signal. The second driver provides a second control signal to the first pixel so that the charged picture signal of the second pixel may be discharged in response to the second control signal. The second scan driver includes a third driver and a fourth driver. The third driver provides a third control signal for applying a picture signal to a second pixel coupled to one of even-numbered scan lines so that the second pixel may be charged with the picture signal in response to the third control signal. The fourth driver provides a fourth control signal to the second pixel so that the charged picture signal of the second pixel may be discharged in response to the fourth control signal.

In still further exemplary embodiments, in a driving a display device having a plurality of scan lines, a plurality of data lines, a plurality of clear lines, and a plurality of pixels coupled to the scan lines, the data lines and the clear lines, a pixel is charged with a picture signal in response to a first control signal provided to one of the scan lines. The picture signal is provided to the data lines. The charged picture signal of the pixel is discharged in response to a second control signal provided to one of the clear lines.

### BRIEF DESCRIPTION OF THE DRAWINGS

The present invention will become more apparent to those of ordinary skill in the art by describing, in detail, exemplary embodiments thereof with reference to the attached drawings, wherein like elements are represented by like reference numerals, which are given by way of illustration only and thus do not limit the exemplary embodiments of the present invention.

FIG. 1 is a schematic equivalent circuit illustrating a unit pixel of an LCD device.

FIG. 2A and FIG. 2B are graphs illustrating an operation of the unit pixel of FIG. 1.

FIG. 3 is a schematic block diagram illustrating an LCD device according to an exemplary embodiment of the present invention.

FIG. 4 is a schematic equivalent circuit illustrating a unit pixel of the LCD device of FIG. 3 according to an exemplary embodiment of the present invention.

FIG. 5 is a schematic block diagram illustrating a scan driver of FIG. 3 according to an exemplary embodiment of the present invention.

FIGS. 6A, 6B and 6C are schematic graphs illustrating an exemplary operation of the scan driver of FIG. 3.

FIGS. 7A, 7B and 7C are schematic graphs illustrating an exemplary operation of scan driver of FIG. 3.

FIG. 8 is a schematic block diagram illustrating a scan driver of FIG. 3 according to an exemplary embodiment of the present invention.

FIG. 9 is a schematic block diagram illustrating an LCD device according to an exemplary embodiment of the present invention.

FIG. 10 is a schematic block diagram illustrating a scan driver of FIG. 9 according to an exemplary embodiment of the present invention.

FIG. 11 is a schematic block diagram illustrating an LCD device according to an exemplary embodiment of the present invention.

FIG. 12 is a schematic block diagram illustrating a scan driver of FIG. 11 according to an exemplary embodiment of the present invention.

### DESCRIPTION OF THE EXEMPLARY EMBODIMENTS

Hereinafter, the exemplary embodiments of the present invention will be explained in more detailed with reference to the accompanying drawings.

Embodiment 1

An LCD device includes a plurality of gate lines for transmitting a scan signal and a plurality of data lines for transmitting a data voltage. The data lines are extended in a first direction, and the gate lines are extended in a second direction substantially perpendicular to the first direction. Also, a plurality of pixels is respectively formed on a region defined by the gate lines and the data lines. The pixels are arranged in a matrix form, which is connected to the respective gate lines and data lines via switching elements.

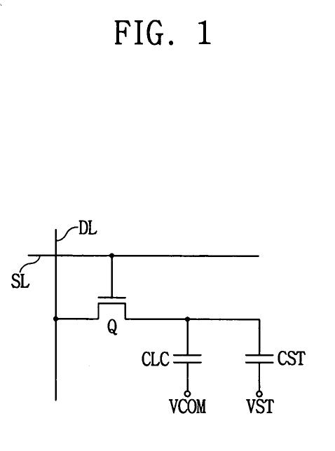

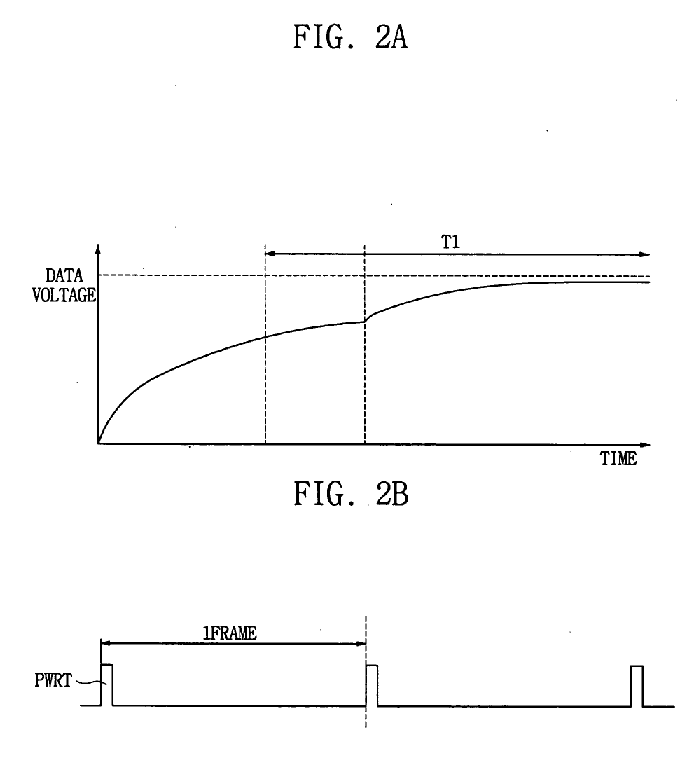

The respective pixels may include a liquid crystal capacitor. An equivalent circuit of respective pixels is shown in FIG. 1, and an operation of the pixel is shown in FIGS. 2A and FIG. 2B.

Referring to FIGS. 1, 2A, and 2B, each of the pixels includes a switching element Q of which a first electrode and a control electrode are respectively connected to a data line DL and a scan line SL, and a liquid crystal capacitor CLC to which a second electrode of the switching element Q and common voltage VCOM are connected, and a storage capacitor CST to which a second electrode of the switching element Q is connected. For example, the switching element Q is a Thin Film Transistor (TFT).

When a gate turn-on voltage signal GON is applied to the scan line SL to turn on the switching element Q, a data voltage provided to the data line DL is outputted to a respective pixel electrode (not shown) via the switching element Q.

Then, an electric field that corresponds to a potential difference between a pixel voltage, which is applied to a corresponding pixel electrode, and a common voltage VCOM, is applied to a liquid crystal (shown as a liquid crystal capacitor in FIG. 1). Thus, the liquid crystal capacitor CLC is charged, and a light transmittance index of the liquid crystal corresponds to the intensity of the electric field. A pixel voltage is maintained for a time interval corresponding to one frame, and the storage capacitor CST of FIG. 1 may be used as an auxiliary capacitor so as to maintain the pixel voltage applied to the pixel electrode.

Meantime, although a response speed of the LCD device depends mainly on a response time of a liquid crystal, when a moving picture is displayed, a ghost image may be remain in a screen since an electric charge needs to be provided to a liquid crystal capacitor CLC within a short time of 1 H, which is less than 20 μs.

Particularly, when electric charge is provided to a liquid crystal capacitor CLC having a response speed of several ms during a time period corresponding to tens of μs, only an amount of electric charge corresponding to an initial capacity thereof is provided to the liquid crystal capacitor CLC. The initial capacity is determined by a voltage difference of the liquid crystal capacitor CLC between a voltage of a present state and a voltage of a previous state thereof, which are applied to a liquid crystal capacitor CLC. Thus, when the voltage difference corresponding to a previous state is not a desired voltage, a time period corresponding to several frames is required so as to obtain the desired voltage within a time period corresponding to 1 H.

As a solution to the problem of the response speed of LCD device due to an initial capacity of liquid crystal capacity CLC, a method of inputting a voltage higher than the desired voltage to be provided to pixel may be employed.

However, in employing the method, an extra frame memory and a complicated driver circuit are required. In addition, when a compensating look-up table is used, characteristic values of a liquid crystal capacitor such as a cell gap of the liquid crystal may be changed, and proper updates of the compensating look-up table is difficult.

In addition, although brightness may be stabilized after a time period corresponding to one frame, the stability of brightness may not be obtained until one frame ends, so that display quality is deteriorated in applications that display mainly a moving picture such as TV.

Accordingly, in order to enhance display quality of a moving picture, for example, impulse-type display may be employed. According to the principle of impulse-type display, which is used in a principle of a projection machine and an LCD device, a black gray scale data corresponding to a black color is periodically inserted into a pixel so as to periodically prevent a light from being emitted from respective pixels. In order to implement the impulse-type display to which the above principle is applied, for example, a power supply of a backlight may be periodically turned off, or, for example, a black picture may be periodically inserted to a pixel. However, the two methods still have a technological problem.

In other words, in order to implement the impulse-type display by turning on or turning off a backlight, data voltages are applied to the whole pixels of the screen within a time period corresponding to 120 Hz (about 8.35 msec) when a frame frequency is 60 Hz (about 16.7 msec) at high speed, and the backlight are turned off during a time period corresponding to remaining 8.35 msec. Thus, an LED backlight that is able to switch on and off at high speed is required. Of course, even though the high speed LED backlight may be available, since the characteristics of the liquid crystal capacitor CLC may vary with respect to a direction of the scanning when gray scale is represented by the liquid crystal capacitor CLC, a brightness difference between the upper portions and the lower portions of the screen is generated, and so that a uniformity of the brightness is not guaranteed.

As a solution to the problem, it is required a high-speed liquid crystal to which an OCB (Optically Compensated Bend) mode is applied.

In addition, according to a method of implementing the impulse-type display by inserting a black picture into a pixel, when a frame frequency is 60 Hz (16.7 msec), data voltages are applied to the whole pixels of the screen at high speed within a time period corresponding to 120 Hz (about 8.35 msec), and a black picture is inserted into a pixel during a time period corresponding to remaining 8.35 msec.

However, since the impulse-type display method requires a high speed scanning, the impulse-type display method may not be suitable for an LCD device that has a large size and a high resolution and does not have enough electric charging time during which the liquid crystal capacitor CLC of a pixel is charged of a data voltage. A charging time of the liquid crystal capacitor CLC is reduced by a fixed gate delay irrespective of a resolution of the liquid crystal display device. Thus, when the liquid crystal capacitor CLC is charged only during a time period corresponding to 120 Hz, although a charging enable time is reduced to ½ H, the gate delay remains unchanged so that the charging time of a pixel reduces rapidly. In addition, a frame memory needs to be managed at high speed.

Therefore, the impulse-type display method for displaying a moving picture has not widely been used due to the reasons illustrated above.

According to exemplary embodiments of the present invention, whole pixels of a screen may be charged with a data voltage at high speed within a time period corresponding to 120 Hz (i.e. 8.35 msec) when the frame frequency is 60 Hz (i.e. 16.7 msec), and the data voltage charged in the pixel may be discharged during a time period corresponding to remaining 8.35 msec.

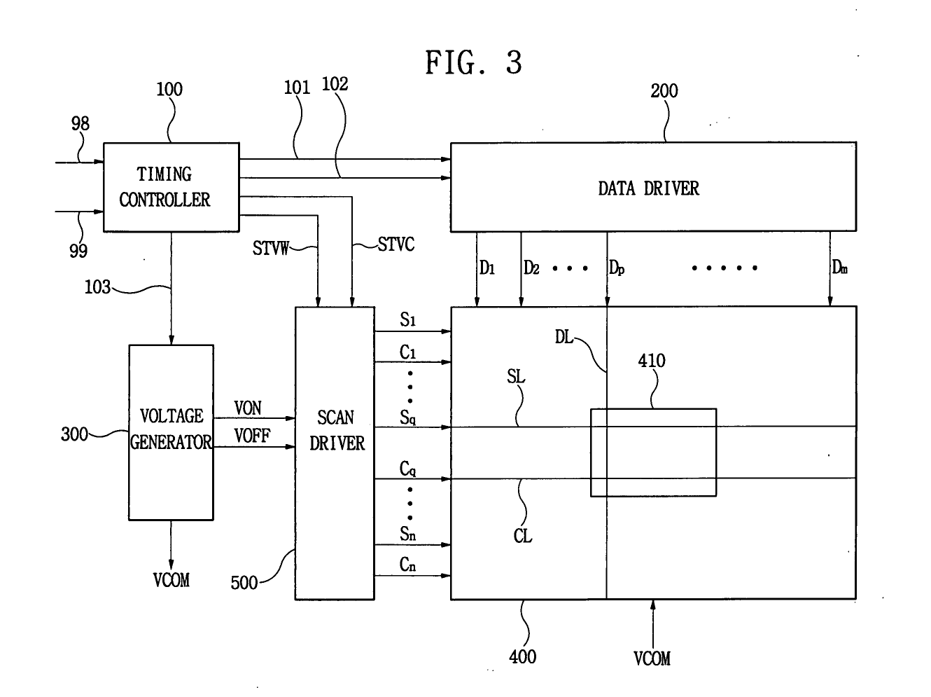

FIG. 3 is a schematic block diagram illustrating a LCD device according to an exemplary embodiment of the present invention. Particularly, FIG. 3 shows an exemplary LCD device having one scan driver disposed in one side of liquid crystal panel.

Referring to FIG. 3, the LCD device according to an exemplary embodiment of the present invention includes a timing controller 100, a data driver 200, a voltage generator 300, a liquid crystal panel 400 and a scan driver 500.

The timing controller 100 receives a first picture signal 98 and a first timing signal 99, provides a second picture signal 101 and a second timing signal 102 to the data driver 200, provides a third timing signal 103 to a voltage generator 300, and provides a start scan signal STVW and a start clear signal STVC to a scan driver 400. The first picture signal 98 and the first timing signal 99 are provided from external device.

The data driver 200 converts the second picture signal to an analog signal, and provides the converted analog signal to a liquid crystal panel 400 in response to the second timing signal 102.

The voltage generator 300 provides a gate turn-on voltage VON and a gate turn-off voltage VOFF to a scan driver 500 and provides a common voltage VCOM to a liquid crystal panel 400 in response to the third timing signal 103.

The liquid crystal panel 400 includes a plurality of data lines DL, a plurality of scan lines SL, a plurality of clear lines CL, and unit pixels 410 that are formed on a region defined by the data lines DL, the scan lines SL and the clear lines CL. The data lines DL are extended in a first direction, and the gate lines GL are insulated from the data lines DL to be extended in a second direction substantially perpendicular to the first direction. The clear lines CL are insulated from the data lines DL and extended in a third direction substantially perpendicular to the first direction.

The scan driver 500 includes an activating section and an inactivating section. The activating section generates scan signals (S1, . . . Sq, . . . and Sn) to activate the pixels, and the inactivating section generates clear signals (C1, . . . Cq, . . . and Cn) to inactivate the pixels. The scan signals and the clear signals are generated based on CPV and L/R signals provided from the timing controller 100, and the gate turn-on voltage VON, the gate turn-off voltage VOFF, and bias voltages VDD and GND provided from the voltage generator 300. Next scan line is selected in response to the CPV signal, and a shift register of a scanning section of the scan driver 500 shifts the scan signal in a direction corresponding to the L/R signal. Particularly, the activating section outputs the scan signals (S1, . . . Sq, . . . and Sn) to a scan line of the liquid crystal panel 400 to activate the pixels. The inactivating section outputs the clear signals (C1, . . . Cq, . . . and Cn) to a clear line of the liquid crystal panel 400 to inactivate the pixels.

For example, a low level of the scan signals (S1, . . . Sq, . . . and Sn) corresponds to the gate turn-off voltage VOFF, and a high level of the scan signals (S1, . . . Sq, . . . and Sn) corresponds to the gate turn-on voltage VON. For example, a low level of the clear signals (C1, . . . Cq, . . . and Cn) corresponds to the gate turn-off voltage VOFF, and a high level of the clear signals (C1, . . . Cq, . . . and Cn) corresponds to the gate turn-on voltage VON.

In addition, the scan driver 500 includes a printed circuit board (PCB) and a flexible printed circuit board (FPC). The flexible printed circuit board is connected between the printed circuit board and the scan lines of the liquid crystal panel 400. A driver integrated circuit (IC) chip may be mounted on the flexible printed circuit board.

Alternately, the scan driver 500 may not adopt the printed circuit board, and only includes the flexible printed circuit board that is connected with the scan lines of the liquid crystal panel 400. The driver IC chip may be mounted on the flexible printed circuit board.

Alternately, a scan driver 500 may not adopt the flexible printed circuit board, and may be directly formed on the liquid crystal panel 400 without the driver IC chip (Hereinafter, referred to as gate IC-less structure) by a semiconductor manufacturing process when the thin film transistors of the pixels are formed on the liquid crystal display panel 400.

A pixel of the liquid crystal panel 400 is charged with a data voltage in response to the scan signal, and the data voltage charged in the pixel is discharged in response to the clear signal.

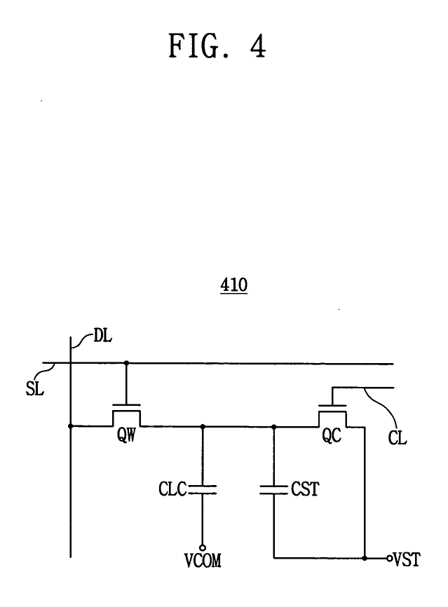

Hereinafter, the unit pixel 410 is illustrated with reference to FIG. 4.

FIG. 4 is a schematic equivalent circuit illustrating the unit pixel of the LCD device of FIG. 3 according to an exemplary embodiment of the present invention.

As shown in FIG. 4, the unit pixel 410 of an LCD device driven by the impulse-type display method includes first and second switching elements QW and QC, a liquid crystal capacity CLC, a storage capacitor CST. The unit pixel 410 is formed on a region defined by a data line DL for transmitting a data voltage and a scan line SL for transmitting a scan signal and a clear line CL for transmitting a clear signal.

The first switching element QW includes a first electrode electrically connected to the data line DL, a control electrode electrically connected to the scan line SL, and a second electrode electrically connected to a first end of the liquid crystal capacitor CLC and a first end of the storage capacitor CST. The first switching element QW is turned on in response to the scan signal, and charges the storage capacitor CST and the liquid crystal capacitor CLC with a data voltage that is transmitted via a first electrode of the first switching element QW.

A second end of the liquid crystal capacitor CLC is electrically connected to a common electrode voltage VCOM. The liquid crystal capacitor CLC is charged with electric charges that correspond to a potential difference between the data voltage and the common electrode voltage.

A first end of the storage capacitor CST is electrically connected to the second electrode of the first switching element QW and the second end of the liquid crystal capacitor CLC. A second end of the storage capacitor CST is electrically connected to a storage voltage VST. The storage capacitor CST is charged with a data voltage that is transmitted via the first switching element QW and provides the charged data voltage to a liquid crystal capacitor CLC during a one-frame period, i.e. a time period corresponding to one frame.

The second switching element QC includes a first electrode electrically connected to the first end of storage capacitor CST, a control electrode electrically connected to a clear line CL and a second electrode electrically connected to the second end of storage capacitor CST. The second switching element QW is turned on in response to the clear signal provided from the clear line, and discharges the data voltage charged in the liquid crystal capacitor CLC and the storage capacitor CST. Accordingly, the liquid crystal capacitor CLC and the storage capacitor CST may have a voltage level that is substantially equal to the storage voltage VST level.

A timing in which the scan signal is applied to a scan line and a timing in which the clear signal is applied to a clear line connected to the same unit pixel to which the scan line is connected have a predetermined interval there between. For example, the clear signal is applied to the scan line after the scan signal has been applied to the clear line. For example, when a frame frequency is 60 Hz (one frame equals 16.7 ms), the clear signal may be applied to the clear line about 8.35 ms (i.e. a time period corresponding to ½ frame) after the scan signal is applied to the scan line.

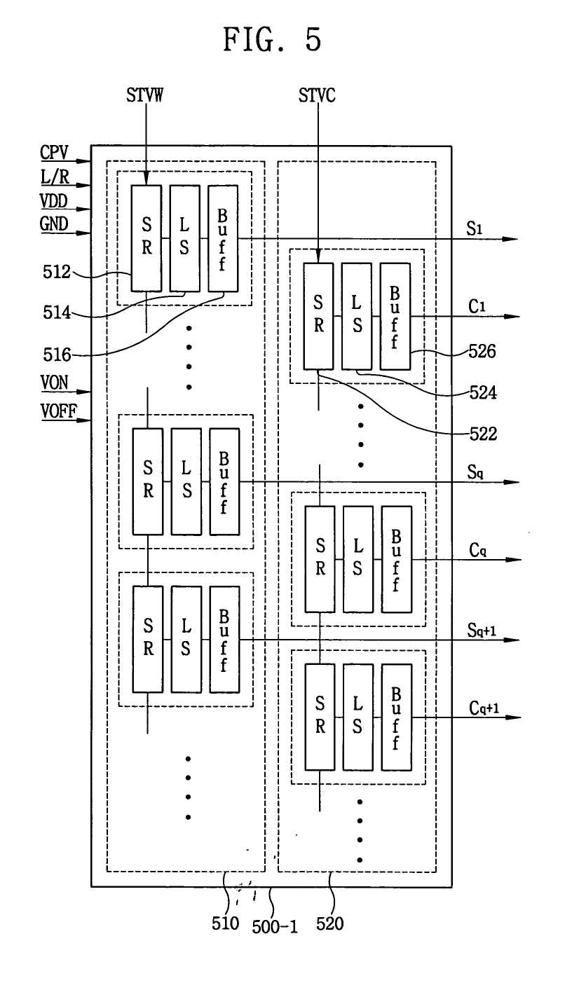

FIG. 5 is a schematic block diagram illustrating a scan driver of FIG. 3 according to an exemplary embodiment of the present invention.

Referring to FIG. 5, the scan driver 500-1 according to an exemplary embodiment of the present invention includes a scanning section 510 and a clearing section 520. The scanning section 510 sequentially generates a plurality of scan signals (S1, . . . Sq, . . . and Sn) to activate the scan lines, and the clearing section 520 sequentially generates a plurality of clear signals (C1, . . . Cq, . . . and Cn) to activate the clear lines.

The scanning section 510 includes a plurality of sub-scanning sections respectively having a first shift register 512, a first level shifter 514 and a first output buffer 516 as a unit.

The first, . . . , qth, . . . , and Nth sub-scanning sections sequentially generate the scan signals S1, . . . Sq, . . . , and Sn, respectively, that activate the scan lines. The scan signals S1, . . . Sq, . . . , and Sn are generated based on PCV and L/R provided from the timing controller 100, a gate turn-on voltage VON, a gate turn-off voltage VOFF, and a bias voltages VDD and GND provided from the voltage generator 300.

Particularly, a first sub-scanning section is activated in response to the start scan signal STVW to generate a first scan signal S1. Then, a second sub-scanning section and third, fourth, . . . , and Nth sub-scanning sections sequentially generate second and third, fourth, . . . , and Nth scan signals, respectively.

The clearing section 520 includes a plurality of sub-clearing sections respectively having a second shift register 522, a second level shifter 524 and a second output buffer 526 as a unit.

The first, . . . , qth, . . . , and Nth sub-clearing sections sequentially generate the clear signals C1, . . . Cq, . . . , and Cn, respectively, that activate the clear lines. Particularly, a first sub-clearing section is activated in response to the start scan signal STVC to generate a first clear signal C1. Then, a second sub-clearing section, third, fourth, . . . , and Nth sub-clearing sections sequentially generate second, third, fourth, . . . , and Nth clear signals, respectively.

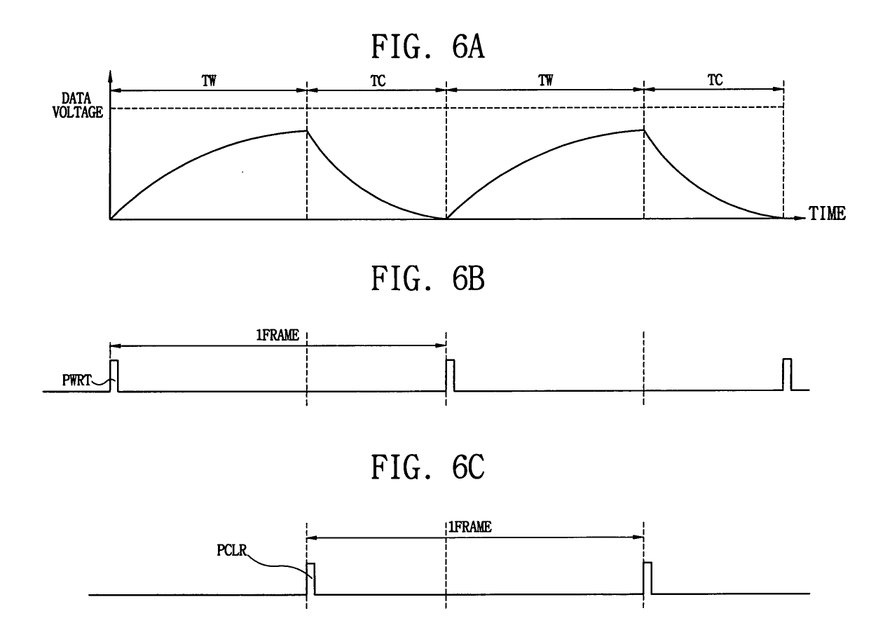

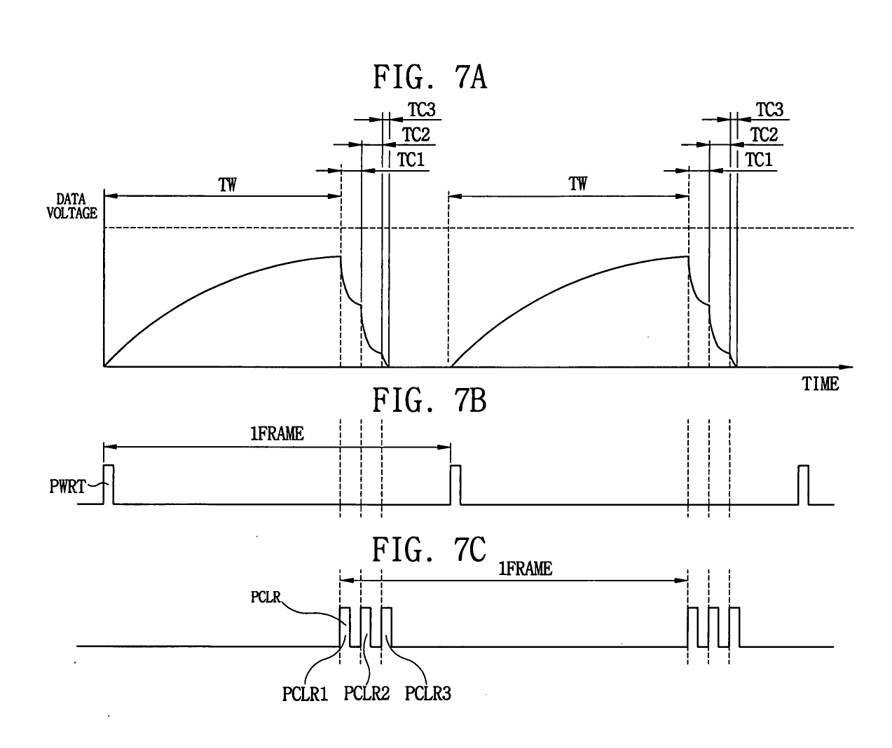

Hereinafter, a process of charging a data line with a data voltage and a process of discharging the data voltage charged in the data line will be described in detail, with reference to FIGS. 6A through 7C.

The data voltage is charged in response to a scan pulse PWRT corresponding to each of the scan signals (S1, . . . Sq, . . . and Sn), and the charged data voltage is discharged in response to a clear pulse PCLR corresponding to each of the clear signals (C1, . . . Cq, . . . , and Cn).

FIGS. 6A, 6B and 6C are schematic graphs illustrating an exemplary operation of the scan driver of FIG. 3.

Referring to from FIG. 3 to FIG. 6C, when the scan pulse PWRT is applied to a scan line at a writing interval TW in one frame, the first switching element QW connected thereto is turned on, and a pixel coupled to the first switching element QW is charged with a predetermined data voltage.

Next, when the clear pulse PCLR is applied to a clear line at a clearing interval TC in one frame, the second switching element QC connected thereto is turned on, and a data voltage charged in a pixel coupled to the second switching element QC is discharged. For example, an active period during which a scan line SL is activated in response to the scan pulse PWRT has a periodic time of one frame. For example, an active period during which the clear line CL is activated in response to the clear pulse PCLR has a periodic time of one frame.

Thus, a pixel is charged with a data voltage in response to the scan pulse PWRT at an initial period of one-frame period, and then the charged data voltage is discharged in response to the clear pulse PCLR at a predetermined time period of one-frame period. Accordingly, an impulse waveform used for displaying a moving picture may be generated.

Although above exemplary embodiment discuss only one clear pulse PCLR that is provided to the corresponding pixel to discharge the data voltage, a plurality of clear pulses PCLR could be provided to the corresponding pixel within one-frame period as shown in FIG. 7C so as to accelerate a speed of discharging the data voltage.

FIGS. 7A, 7B and 7C are schematic graphs illustrating an exemplary operation of the scan driver of FIG. 3.

As shown in FIGS. 7A, 7B and 7C, when a scan pulse PWRT is applied to a scan line at a writing interval TW within one-frame period, a first switching element QW connected thereto is turned on, and a pixel coupled to the first switching element QW is charged with a predetermined data voltage.

Next, when three clear pulses (PCLR1, PCLR2 and PCLR3) are applied to a clear line at a clearing interval TC within one-frame period, a second switching element QC coupled thereto is turned on, and the data voltage charged in a pixel coupled to the second switching element QC is discharged. A plurality of clear pulses PCLR (PCLR1, PCLR2 and PCLR3) could be provided to the corresponding pixel to accelerate a speed of discharging the data voltage.

Although above exemplary embodiment discuss only three clear pulses, clear pulses other than three, for example such as 2 or 4, and so on, could be used.

Particularly, according as a first clear pulse PCLR is applied to a clear line at a first clearing interval TC1, a second switching element QC connected thereto is turned on, and a data voltage charged in a pixel coupled to the second switching element QC is discharged. Next, according as a second clear pulse PCLR2 is applied to a clear line at a second clearing interval TC2, a second switching element QC connected thereto is turned on, and a data voltage charged in a pixel coupled to the second switching element QC is discharged. Next, as a third clear pulse PCLR3 is applied to a clear line at a third clearing interval TC3, a second switching element QC connected thereto is turned on, and a data voltage charged in a pixel coupled to the second switching element QC is discharged.

For example, an active period during which the scan line SL is activated in response to the scan pulse PWRT has a periodical time of one-frame period. In addition, for example, an active period, during which the clear line is activated in response to the first, second and third clear pulses (PCLR1, PCLR2, PCLR3), has a periodical time of one-frame period. For example, the first, second and third clear pulses (PCLR1, PCLR2 and PCLR3) are generated in response to three start clear signals STVC that are applied to clearing section 520.

Thus, a pixel is charged with a data voltage in response to the scan pulse PWRT at an initial period of the one-frame period, and a plurality of clear pulses PCLR may accelerate a speed of discharging the data voltage charged in the corresponding pixel at a predetermined time period of the one-frame period. Accordingly, an impulse waveform suitable for displaying a moving picture may be generated.

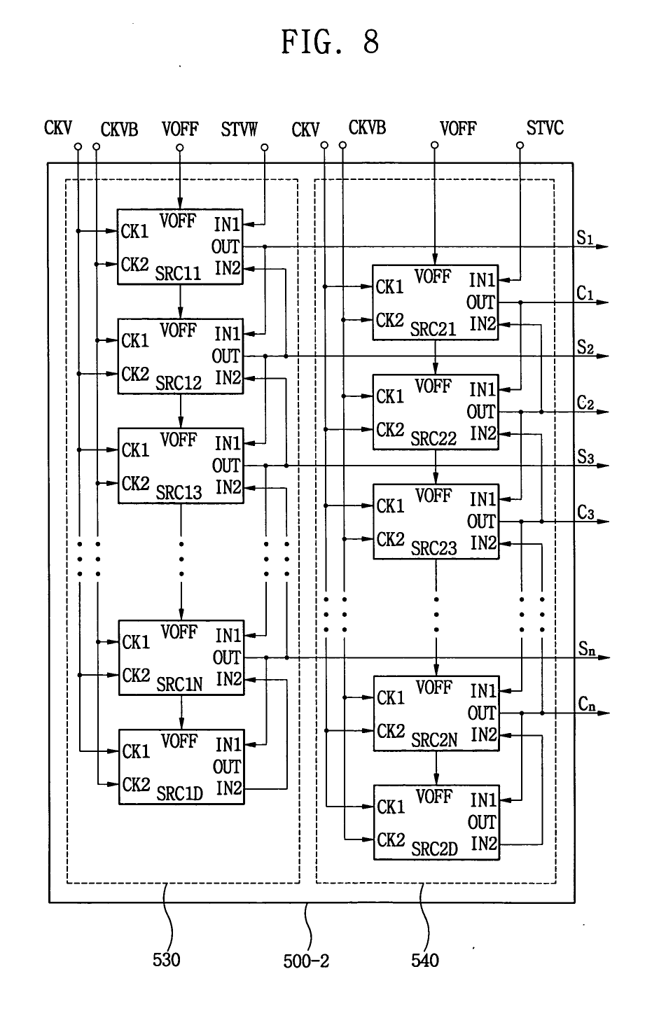

FIG. 8 is a schematic block diagram illustrating a scan driver of FIG. 3 according to an exemplary embodiment of the present invention.

Referring to FIG. 3 and FIG. 8, the scan driver 500-2 according to an exemplary embodiment of the present invention includes a scanning section 530 and a clearing section 540. The scanning section 530 sequentially generates a plurality of scan signals (S1, S2, . . . , and Sn) to activate the scan lines of the liquid crystal panel 400 and the clearing section 540 sequentially generates a plurality of clear signals (C1, C2, . . . , and Cn) to activate the clear lines of the liquid crystal panel 400.

The scanning section 530 may have one shift register. The shift register has multiple stages (SRC11, SRC12, . . . , SRC1N, and SRC1D). For example, an output terminal OUT of a present stage is connected to an input terminal IN of a next stage. The number of the stages (SRC11, SRC12, . . . , and SRC1N) may be N corresponding to the number of the scan lines, and the shift register further includes a dummy stage (SRC1D). Respective stages may have first and second input terminals IN1 and IN2, an output terminal OUT, first and second clock input terminals CK1 and CK2, and a first power voltage terminal VOFF.

The start scan signal STVW is applied to the first input terminal IN1 of a first stage (SRC11). For example, the start scan signal STVW is a pulse signal synchronized with a vertical synchronization signal Vsync.

Each of output signals (S1, S2, . . . Sn) of the stages corresponds to the scan pulse PWRT as illustrated in FIGS. 6A, 6B and 6C or FIGS. 7A, 7B and 7C, and is connected to a corresponding scan line.

For example, a first clock CKV is provided to a first clock terminal CK1 of odd-numbered stages (SRC11, SRC13, . . . ), and a second clock CKVB is provided to a second clock terminal CK2 of the odd-numbered stages (SRC11, SRC13, . . . ).

For example, a second clock CKVB is provided to a first clock terminal CK1 of even-numbered stages (SRC12, SRC14, . . . ), and a first clock CKV is provided to a second clock terminal CK2 of the even-numbered stages (SRC12, SRC14, . . . ). For example, a first clock CKV and a second clock CKVB have opposite phases to each other.

Each of output signals (S2, . . . , and Sn) of next stages (SRC12, SRC13, . . . , and SRC1N) is applied to respective control terminals IN2 of respective stages (SRC11, SRC12, . . . ) as a control signal. That is, the control signal applied to the control terminal IN2 of the present stage is delayed as much as a duty period of an output signal of the present stage.

Accordingly, the output signals (S1, . . . Sn), which have an active level (for example, a high level), of respective stages are sequentially generated so that a scan line corresponding to an activated output signals may be selected.

The clearing section 540 may have one shift register. The shift register has multiple stages (SRC21, SRC22, . . . , SRC2N, and SRC2D). For example, an output terminal OUT of a present stage is connected to an input terminal IN of a next stage.

The number of the stages (SRC21, SRC22, . . . , and SRC2N) may correspond to the number of the scan lines, and the shift register further includes one dummy stage (SRC2D). Respective stages may have first and second input terminals IN1 and IN2, an output terminal OUT, first and second clock input terminals CK1 and CK2, and a first power voltage terminal VOFF.

The start clear signal STVC is applied to the first input terminal IN1 of a first stage (SRC21). The start clear signal STVC is a pulse signal delayed by a predetermined time from a vertical synchronization signal Vsync. The start clear signal STVC is a delayed pulse signal by a predetermined time from a start scan signal STVW within one frame. Only one start clear signal STVC may be used during a one-frame period. Alternately, a plurality of start clear signals STVC may be used so as to accelerate a speed of discharging a data voltage charged in pixel.

Each of output signals (C1, C2, . . . , and Cn) of respective stages corresponds to the clear pulse PCLR as illustrated in FIG. 6 or FIG. 7, and is connected to a corresponding scan line.

For example, a first clock CKV is provided to a first clock terminal CK1 of odd-numbered stages (SRC21, SRC23, . . . ), and a second clock CKVB is provided to a second clock terminal CK2 of the odd-numbered stages (SRC21, SRC23, . . . ).

For example, a second clock CKVB is provided to a first clock terminal CK1 of even-numbered stages (SRC22, SRC24, . . . ), and a first clock CKV is provided to a second clock terminal CK2 of the even-numbered stages. For example, a first clock CKV and a second clock CKVB have opposite phases to each other.

Each of the output signals (C2, . . . . Cn) of next stages (SRC22, SRC23, . . . ) is applied to respective control terminals IN2 of respective stages (SRC21, SRC22 . . . ) as a control signal. That is, the control signal applied to the control terminal IN2 of the present stage is delayed as much as a duty period of an output signal of the present stage.

Accordingly, the output signals (C1, . . . . Cn), which have an active level (for example, a high level), of respective stages are sequentially generated so that a clear line corresponding to an activated output signals may be activated to discharge a data voltage charged in a pixel. When a plurality of start clear signals STVC is assigned within one frame, a plurality of output signals is applied to one clear line within one frame.

As illustrated above, a scan driver having two rows of shift registers may be formed on a flexible printed circuit board, or alternately be formed directly on a liquid crystal panel.

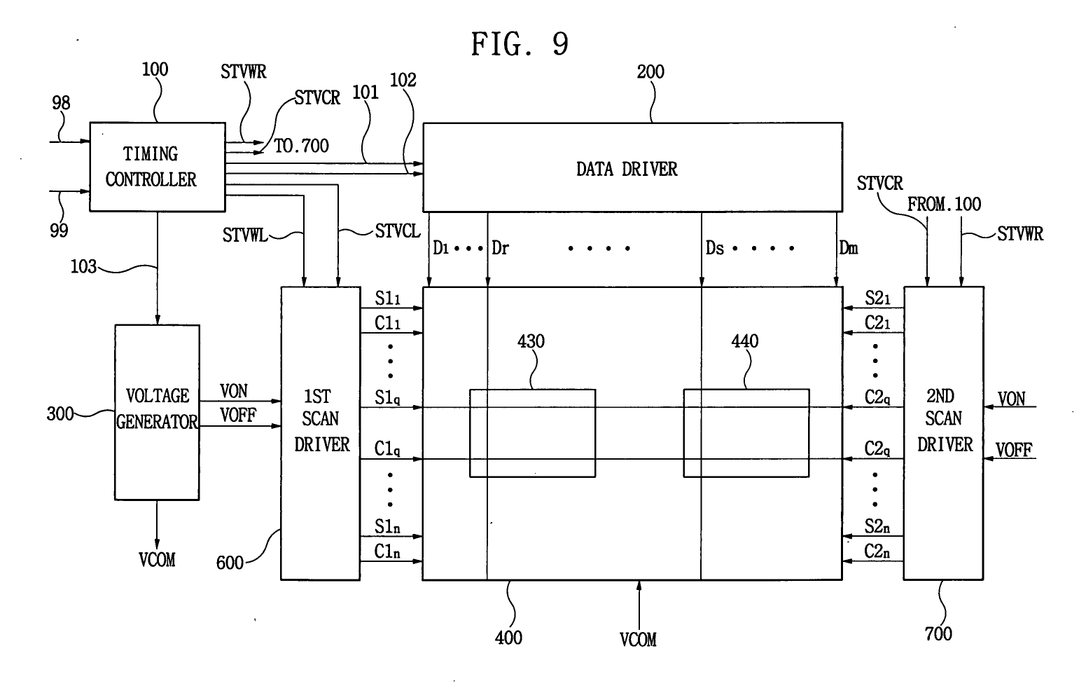

FIG. 9 is a schematic block diagram illustrating an LCD device according to an exemplary embodiment of the present invention. More particularly, FIG. 9 shows an exemplary LCD device having two scan drivers disposed in both sides of liquid crystal panel and connected to a same unit pixel.

Referring to FIG. 9, the LCD device according to an exemplary embodiment of the present invention includes a timing controller 100, a data driver 200, a voltage generator 300, a liquid crystal panel 400, a first scan driver 600 and a second scan driver 700.

The timing controller 100 receives a first picture signal 98 and a first timing signal 99, provides a second picture signal 101 and a second timing signal 102 to a data driver 200, provides a third timing signal 103 to a voltage generator 300, provides fourth and fifth timing signals STVWL and STVCL to the first scan driver 600, and provides sixth and seventh timing signals STVWR and STVCR to a second scan driver 700. The first picture signal 98 and the first timing signal 99 may be provided from an external device.

The data driver 200 converts the second picture signal to an analog signal and provides the converted analog signal to a liquid crystal panel 400 in response to the second timing signal 102.

The voltage generator 300 provides a gate turn-on voltage VON and a gate turn-off voltage VOFF to the first scan driver 600 and the second scan driver 700 and provides a common voltage VCOM to a liquid crystal panel 400, in response to a third timing signal 103.

The liquid crystal panel 400 includes a plurality of data lines DL, a plurality of scan lines SL, a plurality of clear lines CL, and first and second unit pixels 430 and 440 that are formed on a region defined by the data lines DL, scan lines SL and clear lines CL. The data lines DL are extended in a first direction, and the gate lines GL are insulated from the data lines DL to be extended in a second direction substantially perpendicular to the first direction. The clear lines CL are insulated from the data lines DL and extended in a third direction substantially perpendicular to the first direction.

For example, the first unit pixel 430 may be disposed on a left region of the liquid crystal panel and a second unit pixel 440 may be disposed on a right region thereof, with respect to an observer.

The first scan driver 600 includes a first activating section and a first inactivating section. The first activating section generates a plurality of scan signals (S11, . . . S1q, . . . and S1n) to activate the pixels, and generates a plurality of clear signals (C11, . . . C1q, . . . and C1n) to inactivate the pixels. The scan signals and the clear signals are generated based on the CPV and the L/R signals provided from the timing controller 100, and the gate turn-on voltage VON, the gate turn-off voltage VOFF, and bias voltages VDD and GND provided from the voltage generator 300.

Particularly, the first activating section provides the scan signals (S11, . . . S1q, . . . and S1n) to the first unit pixel 430 of the liquid crystal panel 400 in response to the fourth timing signal STVWL. The inactivating section provides the clear signals (C11, . . . C1q, . . . and C1n) to the first unit pixel 430 of the liquid crystal panel 400 in response to the fifth timing signal STVCL.

For example, a low level of the scan signals (S11, . . . S1q, . . . and S1n) corresponds to the gate turn-off voltage VOFF, and a high level of the scan signals (S11, . . . S1q, . . . and S1n) corresponds to the gate turn-on voltage VON. For example, a low level of the clear signals (C11, . . . C1q, . . . and C1n) corresponds to the gate turn-off voltage VOFF, and a high level of the clear signals (C11, . . . C1q, . . . and C1n) corresponds to the gate turn-on voltage VON.

The second scan driver 700 includes a second activating section and a second inactivating section. The second activating section generates a plurality of scan signals (S21, . . . S2q, . . . and S2n) to activate the pixels, and the second inactivating section generates a plurality of clear signals (C21, . . . C2q, . . . and C2n) to inactivate the pixels. The scan signals and the clear signals are generated based on the CPV and L/R signals provided from the timing controller 100 and the gate turn-on voltage VON, the gate turn-off voltage VOFF, and the bias voltages VDD and GND provided from the voltage generator 300.

Particularly, the second activating section provides the scan signals (S21, . . . S2q, . . . and S2n) to the second unit pixel 440 of the liquid crystal panel 400 in response to the sixth timing signal STVWR. The second inactivating section provides the clear signals (C21, . . . C2q, . . . and C2n) to the second pixel unit 440 of the liquid crystal panel 400 in response to the seventh timing signal STVCR.

For example, a low level of the scan signals (S21, . . . S2q, . . . and S2n) corresponds to the gate turn-off voltage VOFF, and a high level of the scan signals (S21, . . . S2q . . . and S2n) corresponds to the gate turn-on voltage VON. In addition, for example, a low level of the clear signals (C21, . . . C2q, . . . and C2n) corresponds to the gate turn-off voltage VOFF, and a high level of the clear signals (C21, . . . C2q, . . . and C2n) corresponds to the gate turn-on voltage VON.

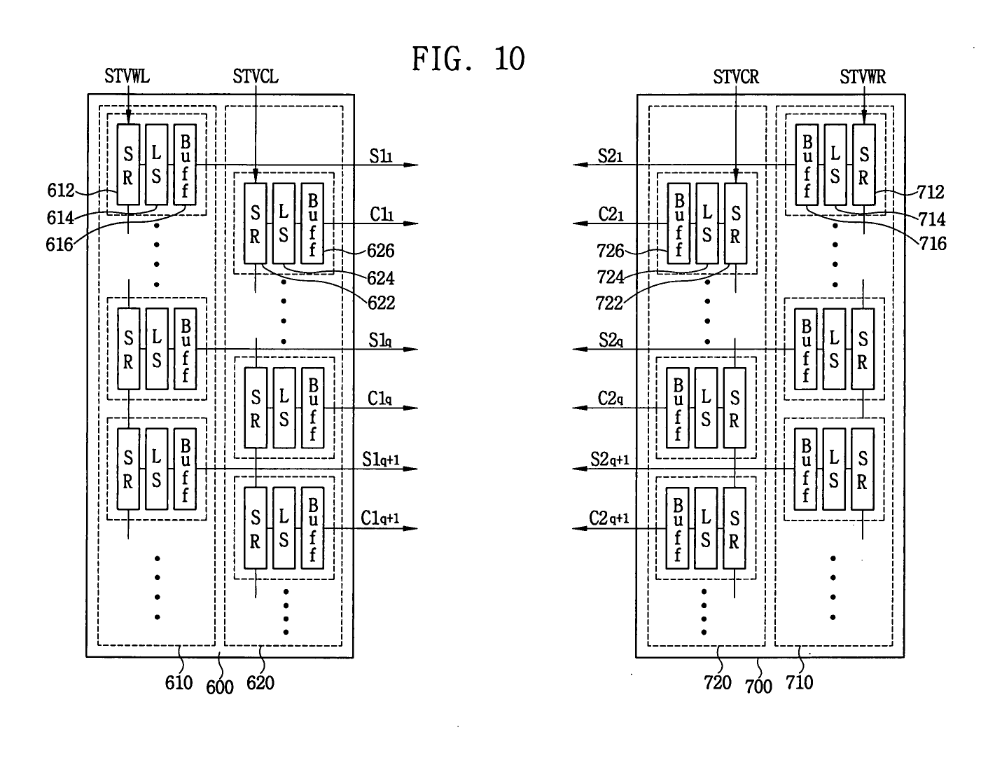

FIG. 10 is a schematic block diagram illustrating a scan driver of FIG. 9 according to an exemplary embodiment of the present invention.

Referring to FIG. 10, the scan driver according to an exemplary embodiment of the present invention has a first scan driver 600 and a second driver 700.

The first scan driver 600 includes a first scanning section 610 and a first clearing section 620. The first scanning section 610 sequentially generates a plurality of scan signals (S11, . . . S1q, S1q+1, . . . ) to activate the scan lines, and the clearing section 620 sequentially generates a plurality of clear signals (C11, . . . C1q, . . . and C1n) to activate the clear lines.

The second scan driver 700 includes a second scanning section 710 and a second clearing section 720. The second scanning section 710 sequentially generates a plurality of scan signals (S21, . . . S2q, S2q+1, . . . ) to activate the scan lines, and the clearing section 720 sequentially generates a plurality of clear signals (C21, . . . C2q, C2q+1 . . . ) to activate the clear lines.

The first scanning section 610 includes a plurality of sub-scanning sections having a first shift register 612, a first level shifter 614 and a first output buffer 616 as a unit. The respective sub-scanning sections sequentially generate the scan signals (S11, . . . S1q, S1q+1, . . . ) that activate the scan lines disposed on the liquid crystal panel 400.

The first clearing section 620 includes a plurality of sub-clearing sections having a second shift register 622, a second level shifter 624 and a second output buffer 626 as a unit. The respective sub-clearing sections sequentially generate the clear signals (C11, . . . C1q, C1q+1 . . . ) that activate the clear lines disposed on the liquid crystal panel 400.

The second scanning section 710 includes a plurality of sub-scanning sections having a first shift register 712, a first level shifter 714 and a first output buffer 716 as a unit. The respective sub-scanning sections sequentially generate the scan signals (S21, . . . S2q, S2q+1, . . . ) that activate the scan lines disposed on the liquid crystal panel 400.

The second clearing section 720 includes a plurality of sub-clearing sections having a second shift register 722, a second level shifter 724 and a second output buffer 726 as a unit. The respective sub-clearing sections sequentially generate the clear signals (C21, . . . C2q, C2q+1 . . . ) that activate the clear lines disposed on the liquid crystal panel 400.

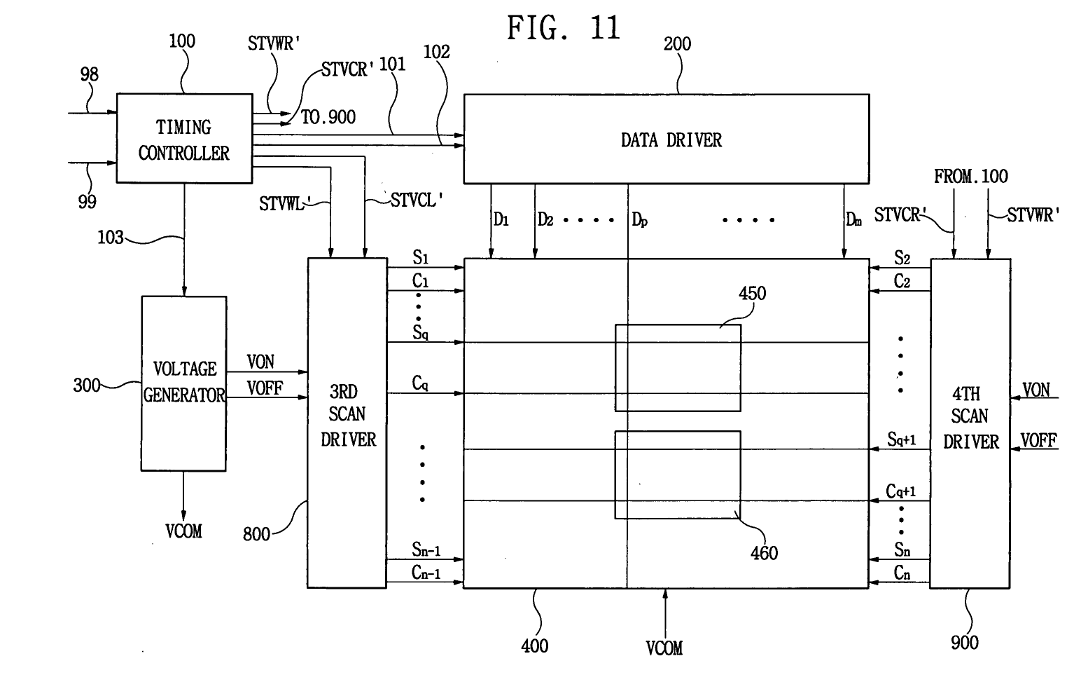

FIG. 11 is a schematic block diagram illustrating an LCD device according to an exemplary embodiment of the present invention. More particularly, FIG. 11 shows an exemplary LCD device having two scan drivers disposed in both sides of the liquid crystal panel and each of the two scan drivers connected to different unit pixels.

Referring to FIG. 11, the LCD device according to an exemplary embodiment of the present invention includes a timing controller 100, a data driver 200, a voltage generator 300, a liquid crystal panel 400, a third scan driver 800 and a fourth scan driver 900.

The timing controller 100 respectively receives a first picture signal 98 and a first timing signal 99, provides a second picture signal 101 and a second timing signal 102 to the data driver 200, provides a third timing signal 103 to the voltage generator 300, provides fourth and fifth timing signals STVWL′ and STVCL′ to the third scan driver 800, and provides a sixth and a seventh timing signal STVWR′ and STVCR′ to the fourth scan driver 900. The first picture signal 98 and the first timing signal 99 may be provided from an external device.

The data driver 200 converts the second picture signal to an analog signal, and provides the converted analog signal to the liquid crystal panel 400 in response to the second timing signal 102.

The voltage generator 300 provides a gate turn-on voltage VON and a gate turn-off voltage VOFF to the third scan driver 800 and the fourth scan driver 900, and provides a common voltage VCOM to the liquid crystal panel 400 in response to the third timing signal 103.

The liquid crystal panel 400 includes a plurality of data lines DL, a plurality of scan lines SL, a plurality of clear lines, and third and fourth unit pixels 450, 460 that are formed on a region defined by the data lines DL, scan lines SL and clear lines CL. The data lines DL are extended in a first direction, and the gate lines GL are insulated from the data lines DL to be extended in a second direction substantially perpendicular to the first direction. The clear lines CL are insulated from the data lines DL and extended in a third direction substantially perpendicular to the first direction.

For example, the third unit pixel 450 may be formed on a region corresponding to one of odd-numbered scan lines and a clear line, and a fourth unit pixel 460 may be formed on a region corresponding to one of even-numbered scan lines and a clear line.

The third scan driver 800 includes a third activating section and a third inactivating section. The third activating section generates a plurality of scan signals (S1 . . . Sq, . . . and Sn−1) to activate odd-numbered pixels and the third inactivating section generates a plurality of clear signals (C1, . . . Cq, . . . and Cn−1) to inactivate odd-numbered pixels. The scan signals and the clear signals are generated based on the CPV and L/R signals provided from the timing controller 100, and the gate turn-on voltage VON, the gate turn-off voltage VOFF, and bias voltages VDD and GND provided from the voltage generator 300.

The third activating section generates the scan signals (S1, . . . . Sq, . . . and Sn−1) to a third unit pixel 450 of the liquid crystal panel 400 in response to the fourth timing signal STVWL′, and the third inactivating section generates the clear signals (C1, . . . . Cq, . . . and Cn−1) to a fourth unit pixel 460 of the liquid crystal panel 400 in response to the fifth timing signal STVCL′.

For example, a low level of the scan signals (S1, . . . Sq, . . . and Sn−1) corresponds to the gate turn-off voltage VOFF, and a high level of the scan signals (S1, . . . Sq, . . . and Sn−1) corresponds to the gate turn-on voltage VON. In addition, for example, a low level of the clear signal (C1, . . . Cq, . . . and Cn−1) corresponds to the gate turn-off voltage VOFF, and a high level of the clear signal (C1 . . . Cq, . . . and Cn−1) corresponds to the gate turn-on voltage VON.

The fourth scan driver 900 includes a fourth activating section and a fourth inactivating section. The fourth activating section generates a plurality of scan signals (S2, . . . Sq+1, . . . and Sn) to activate even-numbered pixels and the fourth inactivating section generates a plurality of clear signals (C2, . . . . Cq+1, . . . and Cn) to inactivate even-numbered pixels. The scan signals and the clear signals are generated based on the CPV and L/R signals provided from the timing controller 100, and the gate turn-on voltage VON, the gate turn-off voltage VOFF, and the bias voltages VDD and GND provided from the voltage generator 300.

The fourth activating section generates the scan signal (S2, . . . Sq+1, . . . and Sn) to the fourth unit pixel 460 of the liquid crystal panel 400 in response to the sixth timing signal STVWR′, and the second inactivating section generates the clear signal (C2, . . . Cq+1, . . . and Cn) is to the second unit pixel 440 of the liquid crystal panel 400 in response to the seventh timing signal STVCR′.

For example, a low level of the scan signals (S2, . . . Sq+1, . . . and Sn) corresponds to the gate turn-off voltage VOFF, and a high level of the scan signals (S2, . . . Sq+1, . . . and Sn) corresponds to the gate turn-on voltage VON. For example, a low level of the clear signals (C2, . . . . Cq+1, . . . and Cn) corresponds to the gate turn-off voltage VOFF, and a high level of the clear signals (C2, . . . . Cq+1, . . . and Cn) corresponds to the gate turn-on voltage VON.

The respective scan signals (S2, . . . . Sq+1, . . . and Sn) and the respective clear signals (C2, . . . Cq+1, . . . and Cn) may be outputted in different timing.

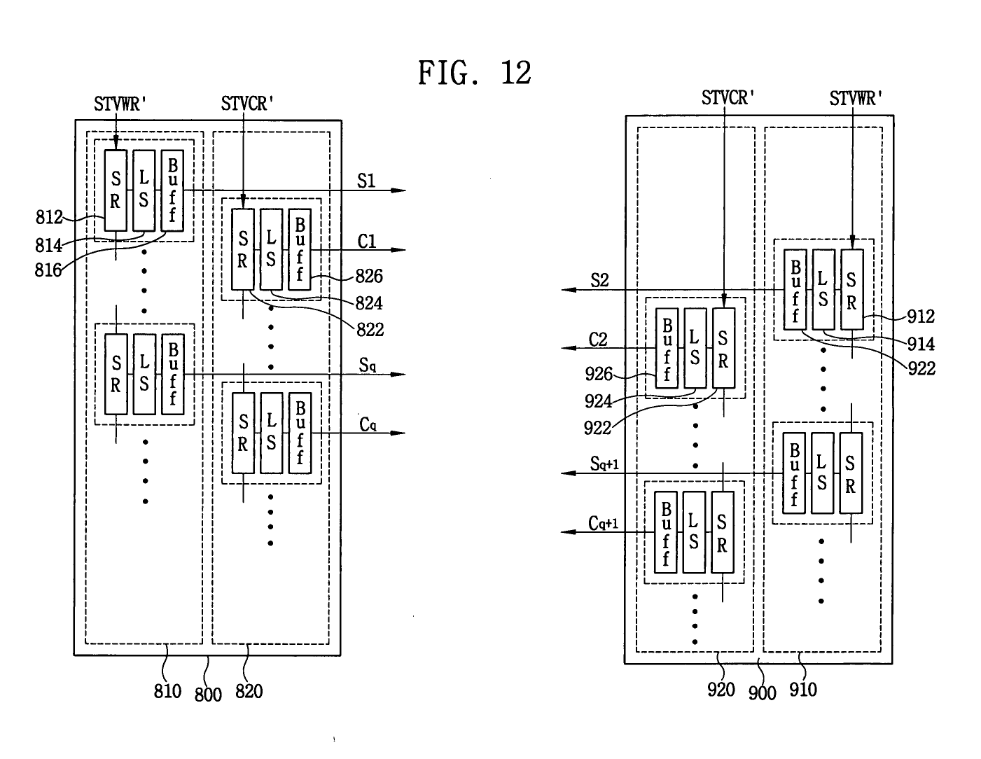

FIG. 12 is a schematic block diagram illustrating a scan driver of FIG. 11 according to an exemplary embodiment of the present invention.

Referring to FIG. 12, the scan driver according to an exemplary embodiment of the present invention has a third scan driver 800 and a fourth driver 900.

The third scan driver 800 includes a first scanning section 810 and a first clearing section 820. The first scanning section 810 sequentially generates a plurality of scan signals (S1, . . . Sq, . . . ) to activate the scan lines, and the clearing section 820 sequentially generates a plurality of clear signals (C1, . . . Cq, . . . ) to activate the clear lines.

The second scan driver 900 includes a second scanning section 910 and a second clearing section 920. The second scanning section 910 sequentially generates a plurality of scan signals (S2, . . . Sq+1 . . . ) to activate the scan lines, and the clearing section 920 sequentially generates a plurality of clear signals (C2, . . . Cq+1, . . . ) to activate the clear lines.

The first scanning section 810 includes a plurality of sub-scanning sections respectively having a first shift register 812, a first level shifter 814 and a first output buffer 816 as a unit. The respective sub-scanning sections sequentially generate the scan signals (S1, . . . Sq, . . . ) that activate odd-numbered scan lines disposed on the liquid crystal panel 400.

The first clearing section 820 includes a plurality of sub-clearing sections respectively having a second shift register 822, a second level shifter 824 and a second output buffer 826 as a unit. The respective sub-clearing sections sequentially generate the clear signals (C1, . . . Cq, . . . ) that activate odd-numbered clear lines disposed on the liquid crystal panel 400.

The second scanning section 910 includes a plurality of sub-scanning sections respectively having a first shift register 912, a first level shifter 914 and a first output buffer 916 as a unit. The respective sub-scanning sections sequentially generate the scan signals (S2, . . . Sq+1, . . . ) that activate even-numbered scan lines disposed on the liquid crystal panel 400.

The second clearing section 920 includes a plurality of sub-clearing sections respectively having a second shift register 922, a second level shifter 924 and a second output buffer 926 as a unit. The respective sub-clearing sections sequentially generate the clear signals (C2, . . . Cq+1, . . . ) that activate even-numbered clear lines disposed on the liquid crystal panel 400.

Although above exemplary embodiments discuss only an LCD device, the scan driver of the present invention could be applied to a Plasma Display Panel (PDP) having an active matrix panel, or an Active Matrix Organic Light Emitting Device (AMOLED) or other various display devices.

According to above illustrated exemplary embodiments of the present invention, the scan driver of a display device has a scanning section for activating (or charging) a pixel of a display panel and a clearing section for inactivating (or discharging) the pixel so that the display quality of a moving picture may be enhanced.

In addition, a scan driver having the scanning section and the clearing section may be disposed in one side of a display panel so that a size of the display panel may be reduced. Further, the number of processes of attaching a driver IC on which the scan driver is mounted may be reduced, and thus manufacturing cost may be reduced.

In addition, since two scan drivers respectively having the scanning section and the clearing section may be disposed in a first side and a second side of the display panel, loads of the scan lines or the clear lines may be reduced so that the scan drivers may be applied to display devices having a large-scale screen.

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

1. A scan driver comprising:
a first driver configured to provide a first control signal to at least one scan line coupled to a pixel, a picture signal being provided to the pixel in response to the first control signal; and
a second driver configured to provide at least one second control signal to at least one clear line coupled to the pixel, the picture signal being discharged in response to the second control signal control.

2. The scan driver of claim 1, wherein the first control signal and the second control signal are provided to the at least one scan line and the at least one clear line, respectively, in a different timing.

3. The scan driver of claim 1, wherein the first driver and the second driver provide the first control signal and the second control signal to the first and second scan lines, respectively, during a first time period corresponding to one frame.

4. The scan driver of claim 1, wherein the second control signal is provided to the second scan line a second time period after the first control signal is provided to the first scan line, the second time period corresponding to ½ frame.

5. The scan driver of claim 1, wherein the second driver provides at least two second control signals during a first time period corresponding to one frame, after the first control signal is provided.

6. The scan driver of claim 1, wherein the pixel has a switching element and a liquid crystal capacitor having a liquid crystal as a dielectric.

7. The scan driver of claim 1, wherein the first driver and the second driver respectively include a shift register, a level shifter and an output buffer.

8. A display device comprising:
a display panel including a plurality of scan lines, a plurality of data lines, a plurality of clear lines, and a plurality of pixels having a first and a second switching elements, the first switching element being coupled to one of the scan lines and one of the data lines, and the second switching element being coupled to one of the clear lines and one of the data lines;
a data driver configured to provide a picture signal to the data lines; and
a scan driver configured to provide a first control signal via the scan lines to the first switching element so that the pixel may be charged with the picture signal in response to the first control signal, and configured to provide a second control signal via the clear lines to the second switching element so that the picture signal charged in the pixel may be discharged via the second switching element in response to the second control signal.

9. The display device of claim 8, wherein the scan driver includes a first driver configured to provide the first control signal to the scan lines and a second driver configured to provide the second control signal to the clear lines, the first and the second drivers are disposed on a flexible printed circuit board or on the display panel.

10. The display device of claim 8, wherein the display panel includes a liquid crystal capacitor of which one end is coupled to the first switching element.

11. The display device of claim 8, wherein the scan driver provides the first and the second control signals in a different timing during a first time period corresponding to one frame.

12. The display device of claim 11, wherein the second driver provides at least two second control signals during a first time period corresponding to one frame, after the first control signal is provided.

13. The display device of claim 8, wherein the scan driver comprising:
a first scan driver including a first driver and a second driver, the first driver providing the first control signal via one of the scan lines to a first pixel that is disposed on a first region of the display panel, and the second driver providing the second control signal via one of the clear lines to the first pixel, and
a second scan driver including a third driver and a fourth driver, the third driver providing a third control signal via one of the scan lines to a second pixel that is disposed on a second region of the display panel so that the second pixel may be charged with the picture signal in response to the third control signal, and the fourth driver providing a fourth control signal via one of the clear lines to the second pixel so that the charged picture signal of the second pixel may be discharged in response to the fourth control signal.

14. The display device of claim 8, wherein the scan driver comprising:
a first scan driver including a first driver and a second driver, the first driver providing the first control signal to a first pixel coupled to one of odd-numbered scan lines, and the second driver providing the second control signal to the first pixel, and
a second scan driver including a third driver and a fourth driver, the third driver providing a third control signal to a second pixel coupled to one of even-numbered scan lines so that the second pixel may be charged with the picture signal in response to the third control line, and the fourth driver providing a fourth control signal to the second pixel so that the charged picture signal of the second pixel may be discharged in response to the fourth control signal.

15. A display device comprising:
a display panel including a plurality of scan lines, a plurality of data lines, a plurality of clear lines, and a plurality of pixels coupled to the scan lines, the data lines and the clear lines;
a data driver configured to provide a picture signal to the data lines;
a first scan driver including a first driver and a second driver, the first driver providing a first control signal to a first pixel coupled to one of odd-numbered scan lines so that the first pixel may be charged with a picture signal in response to the first control signal, and the second driver providing a second control signal to the first pixel so that the charged picture signal of the second pixel may be discharged in response to the second control signal; and
a second scan driver including a third driver and a fourth driver, the third driver providing a third control signal for applying a picture signal to a second pixel coupled to one of even-numbered scan lines so that the second pixel may be charged with the picture signal in response to the third control signal, and the fourth driver providing a fourth control signal to the second pixel so that the charged picture signal of the second pixel may be discharged in response to the fourth control signal.

16. The display device of claim 15, wherein the first scan driver provides the first and the second control signals in a different timing during a first time period corresponding to one frame,
the second scan driver provides the third and the fourth control signals in a different timing during the first time period corresponding to one frame, and
the first control signal and the third control signal are provided in a different timing.

17. The display device of claim 15, wherein the first scan driver provides the first and the second control signals during a first time period corresponding to one frame in a different timing,
the second scan driver provides the third and the fourth control signals during the first time period corresponding to one frame in a different timing, and
the second control signal and the fourth control signal are provided in a different timing.

18. A method of driving a display device, the display device having a plurality of scan lines, a plurality of data lines, a plurality of clear lines, and a plurality of pixels coupled to the scan lines, the data lines and the clear lines, comprising:
charging a pixel with a picture signal in response to a first control signal provided to one of the scan lines, the picture signal being provided to the data lines; and
discharging the charged picture signal of the pixel in response to a second control signal provided to one of the clear lines.

19. The display device of claim 18, wherein the first and the second control signals are provided during a first time period corresponding to one frame.

20. The display device of claim 18, wherein the second control signal is provided at least one time during a first time period corresponding to one frame.

21. A scan driver for driving a display device, the display device having a plurality of pixels, and a plurality of data lines, a plurality of scan lines, and a plurality of clear lines that are coupled to the pixels, comprising:
a first driver configured to provide a first control signal to the at least one of the scan lines, and configured to control at least one pixel of the pixels so that the at least one pixel is charged with a picture signal in response to the first control signal; and
a second driver configured to provide at least one second control signal to at least one of the clear lines so that the charged picture signal of the at least one pixel is discharged in response to the second control signal.
